(19) United States
(12) Patent Application Publication
(10) Pub. No.: US 2002/0088345 A1
(43) Pub. Date: Jul. 11, 2002

(54) Construction of a cross stream membrane chamber module for the selective separation of hydrogen from reformate gas

(76) Inventor: Volker Formanski, Alsenborn (DE)

Correspondence Address: CARY W. BROOKS, General Motors CorpORATION, Legal Staff, Mail Code 482-C23-B21, P.O. Box 300, Detroit, MI, 48265-3000, US

(21) Appl. No.: 10/000,684

(22) Filed: Oct. 31, 2001

(30) Foreign Application Priority Data
Nov. 30, 2000 (DE) 10059515.4

(51) Int. Cl. B01D 53/22

(52) U.S. Cl. 96/8; 95/55

(57) ABSTRACT

An apparatus for the separation of hydrogen from a gas mixture comprising hydrogen and at least one further gas, wherein hollow structures with a wall consisting of a membrane permeable for hydrogen are disposed in a diffusion chamber, the mixture can be led into and through the diffusion chamber, the hydrogen which diffuses through the membrane into the hollow structures can be led out of the hollow structures and the gas mixture depleted with respect to its hydrogen content can be led out of the diffusion chamber is characterized in that the hollow structures comprise crossed tubes which open at least at their one end into a collecting chamber which leads away the hydrogen. Through this arrangement of the hollow structures, turbulence arises in the diffusion chamber which improves the efficiency of the separation process.

### TECHNICAL FIELD

The present invention relates to an apparatus and to a method for the separation of hydrogen from a gas mixture comprising hydrogen and at least one further gas, wherein hollow structures with a wall consisting of a membrane permeable for hydrogen are disposed in a diffusion chamber, the mixture can be led into and through the diffusion chamber, the hydrogen which diffuses through the membrane into the hollow structures can be led out of the hollow structures and the gas mixture depleted with respect to its hydrogen content can be led out of the diffusion chamber.

### BACKGROUND OF THE INVENTION

Such apparatuses and methods are important for the supply of hydrogen to low temperature fuel cells, particularly against the background of use of such fuel cell systems in vehicles. It is possible to make hydrogen gas available for mobile applications, in particular in motor vehicles through the reformation of hydrocarbons, for example in the form of alcohols or petroleum or diesel fuels. The idea of reformation is to obtain a hydrogen-rich synthesized gas from the hydrocarbon, with the hydrogen, freed of other gas components, being reacted in the fuel cells with atmospheric oxygen to yield electrical energy with the formation of water.

The reformate gas which arises during reformation consists essentially of a mixture of the gas components hydrogen, carbon dioxide, carbon monoxide and water vapor. Depending on the way the process is carried out, the reformate gas also contains residual components of hydrocarbons or alcohol compounds and also quantities of oxygen and nitrogen. The actual conversion of the fuel into electrical energy which takes place in the fuel cell, however, only requires hydrogen gas. The remaining gas components of the reformate gas impair the effectiveness of the reaction in the fuel cell through undesired side reactions or adsorption processes at the fuel cell membranes coated with a catalyst and also through reduction of the external material transport of the hydrogen molecules to the membrane surface.

In order to overcome this disadvantage, gas cleaning processes are known which use metal membranes permeable for hydrogen alone or predominantly for hydrogen. Such fine cleaning processes offer the clear advantage that hydrogen gas on its own can be offered to the low temperature fuel cell for conversion into electrical energy. Metal membranes for the working up of hydrogen are principally manufactured from an alloy of palladium/silver with different proportions by mass.

The ratio between the volume flow of hydrogen in the reformate gas and the clean gas volume which is separated off via the metal membrane is termed the gain factor. This factor is essentially determined by the pressure relationships, by the proportion of hydrogen in the reformate and also by the operating temperature, by the membrane thickness and by the membrane surface. A reduction of the membrane thickness leads, on the one hand, to an improvement of the hydrogen permeability, but also to a reduction of the mechanical stability which restricts the scope of use and the dynamic characteristics. In order to construct a compact gas preparation stage, the optimization of the membrane area related to the total volume and of the material transport relationships between the gas phase and the membrane surface is necessary. This optimization influences the assessment of the system and of the fuel cell drive system as a whole.

### SUMMARY OF THE INVENTION

In accordance with the current state of the art, metal membranes are used for gas separation, either as flat foils or as cylindrical tubes. For example, separating devices of the initially-named kind are offered by the Johnson Matthey Company, comprising a hollow tubular structure having a membrane coaxially disposed within a cylinder. It is possible to increase the volume specific surface area of the membrane if, instead of using a hollow structure in the form of a single membrane tube, a plurality of such membrane tubes of small diameter are arranged in parallel to one another in a bundle. With an embodiment of this kind, the membrane cylinders having the form of cylindrical tubes are inserted into membrane chambers which are supplied with the feed gas or reformate gas radially from the outside. The permeate or prepared hydrogen gas which permeates through the membrane foil of the membrane cylinders is led away axially. The retentate or residual gas which is not separated out by the membrane is led out of the membrane chamber.

In an apparatus of the initially-named kind, not only is the highest possible specific surface area of the membrane which is made available for the separation of the hydrogen important, but the optimization of the gas transport and heat transport relationships between the gas phase and the membrane is important for the processing of the reformate gas for fuel cells.

The object of the present invention is to provide an apparatus or a method of the initially-named kind in which both a comparatively high specific surface area of the membrane as well as an optimization of the material and heat transport relationships between the gas phase and the membrane can be achieved for the processing of reformate gases for fuel cells.

In order to satisfy this object, an apparatus of the initially-named kind is provided, in accordance with a first variation of the invention, such that the hollow structures consist of crossing tubes which open at at least one end into a collecting chamber which leads away the hydrogen.

In accordance with a second variant of the invention, provision is made, in accordance with the invention, that the diffusion chamber carrying the gas mixture includes inbuilt structures and is formed in the manner of any desired static mixer for liquid components, with the inbuilt structures forming the hollow structures which consist at least partly of the membrane permeable for hydrogen and which open at at least one point into a collecting chamber which is formed for the leading away of the hydrogen which diffuses through the membrane.

Both variants are characterized in that the hollow structures are designed in order to ensure a turbulent flow of the gas mixture through the diffusion chamber carrying the gas mixture and that they open at at least one point into a collecting chamber for leading away the hydrogen.

A particularly preferred embodiment of the invention is characterized in that elongate collecting chambers are provided at opposite sides of the diffusion chamber carrying the gas mixture and between its ends, with the crossing tubes opening into the collecting chambers at at least one end.

The method of the invention is so conceived that the hollow structures are designed to ensure a turbulent flow of the gas mixture through the diffusion chamber carrying the gas mixture and to lead the hydrogen separated out from the gas mixture into at least one collecting chamber which leads the hydrogen away.

The apparatus of the invention and the method of the invention ensure that material transport resistances and heat transport resistances such as arise in a customary membrane chamber module are reduced by the cross flow guidance of the reformate gas over the correspondingly arranged hollow structures by the turbulent flows which arise under certain operating conditions. In this way, high recovery rates of hydrogen per unit volume of the apparatus can be achieved.

The invention thus exploits the heat and material transport characteristic of crossed channel structures which are known, per se, and which are, for example, used in so-called static mixers, in order to increase the performance of membrane modules in the selective separation of one gas component, here hydrogen, whereas in a static mixer, the object is to homogeneously mix two or more components in a volume which is as small as possible. The invention pursues a quite different object, namely that of separating gas components, with the design of separating devices in accordance with the invention being based on static mixers to the extent that the solid inbuilt structures used there are present here in hollow form, with the wall or at least a part of the wall of the hollow structure consisting of a membrane permeable for hydrogen.

Through the increase of the specific recovery factor of a hydrogen separating apparatus achieved in accordance with the invention, i.e., the separating performance per unit of volume, one succeeds in not only ensuring a compact construction, but rather also in saving weight in total, which makes a fuel cell drive system even more attractive.

The important advantages of the design in accordance with the invention of a membrane module for hydrogen separation from reformate gases is given by the high volume related membrane surface area together with the flow conditions at the feed side which can be achieved under certain operating conditions.

Preferred embodiments of the invention are to be found in the further description and also in the drawings and in the claims.

### BRIEF DESCRIPTION OF THE DRAWINGS

The invention will be explained in the following in more detail with reference to different embodiments and to the drawings in which are shown:

FIG. 1 is a schematic representation of a separating apparatus in accordance with the invention in a view partly sectioned in the longitudinal direction;

FIG. 2 is a perspective illustration of a cross section through a separating apparatus in accordance with the invention similar to that of FIG. 1 but to an enlarged scale;

FIG. 3 is a perspective illustration of an alternative embodiment to that of FIG. 2 in a highly schematic form; and

FIG. 4 is a schematic illustration of an alternative hollow structure which is known per se from the field of static mixtures, but in a modified form for the purpose of use in a separating apparatus in accordance with the invention.

### DESCRIPTION OF THE PREFERRED EMBODIMENT

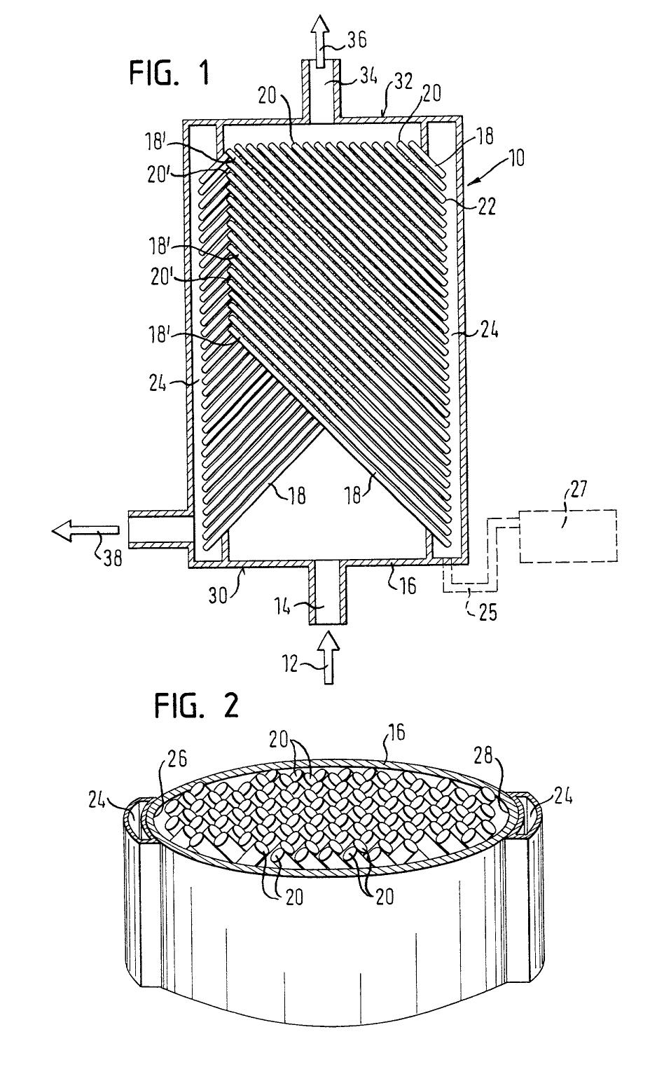

FIG. 1 shows a separating apparatus 10 for the separation of hydrogen from a gas mixture which flows in accordance with the arrow 12 into the inlet 14 of a diffusion chamber 16. This gas mixture is preferably a reformate which comes from a reforming unit or hydrogen preparation system and consists, for example, of H₂, CO₂, CO, H₂O, CH₄, CH₃OH and N_{2.}

Within the diffusion chamber there are many hollow structures which consist of crossing tubes 18. The tubes 18, the walls of which consist in a manner known, per se, of membranes permeable for H₂, are closed at one end, for example at 20 in FIG. 1, and open at their other respective end 22 into a respective collecting chamber 24 of which two such chambers are present in the embodiment of FIGS. 1 and 2.

The elongated collecting chambers arranged at opposite sides 26 and 28 of the diffusion chamber 16 extend in this example between the end faces 30 and 32 of the diffusion chamber 16, which leads the gas mixture from the inlet 14 at the end face 30 to the outlet 34 at the end face 32. The outlet 34 leads the retentate, i.e., a reformate which is at least partly depleted with respect to its hydrogen component, out of the diffusion chamber 16 in accordance with the arrow 46. That is to say, the chemical composition of the retentate consists of H₂, CO₂, CO, H₂O, CH₄, CH₃OH and N₂, but the proportion of hydrogen is significantly lower than for the inflowing reformate.

The hydrogen which is separated out from the gas mixture by the tubular hollow structures 18 and which passes by diffusion through the membrane-like walls 18 into the tubes and through them into the collecting chamber 24 leaves the collecting chamber 24 as a permeate, i.e., of H₂, in accordance with the arrow 38 in FIG. 1. The elongate chamber 24 at the right-hand side of FIG. 1 is connected via a line, which is not visible in FIG. 1, to the collecting chamber 24 at the left-hand side of FIG. 1.

The possibility also exists of so designing the hollow structures in FIG. 1 that at least some of the tubes open at both ends into a respective collecting chamber 24. For example, the ends 20′ of tubes which are characterized by 18′ in FIG. 1 could be extended so that they open into the collecting chamber 24 at the left-hand side of the apparatus of FIG. 1.

Through the overall structure assembled from crossing tubes, a turbulent flow of the gas mixture takes place, at least at higher flow rates, over at least substantially the whole length of the diffusion chamber 16 which extends from the end face 30 up to the end face 32. This turbulent flow has proved to be favorable for the efficiency of the separating apparatus. On the one hand, the dwell time of the mixture in the diffusion chamber 16 is increased so that more time is available for the diffusion processes. On the other hand, a uniform temperature distribution is present which is on the whole favorable for the heat transport and material transport processes within the diffusion chamber. Thus, the hydrogen recovery factor for the separating apparatus of FIGS. 1 and 2 per unit of volume can be substantially improved by comparison to the previously known separating devices.

FIG. 2 is to be understood schematically at least to the extent that the elongate collecting chambers 24 are only shown for the sake of illustration over a small region at the left and right-hand sides 26,28 of the separating apparatus 10. In practice, they must take up a larger area in order to receive the tube ends of the crossing tubes 18.

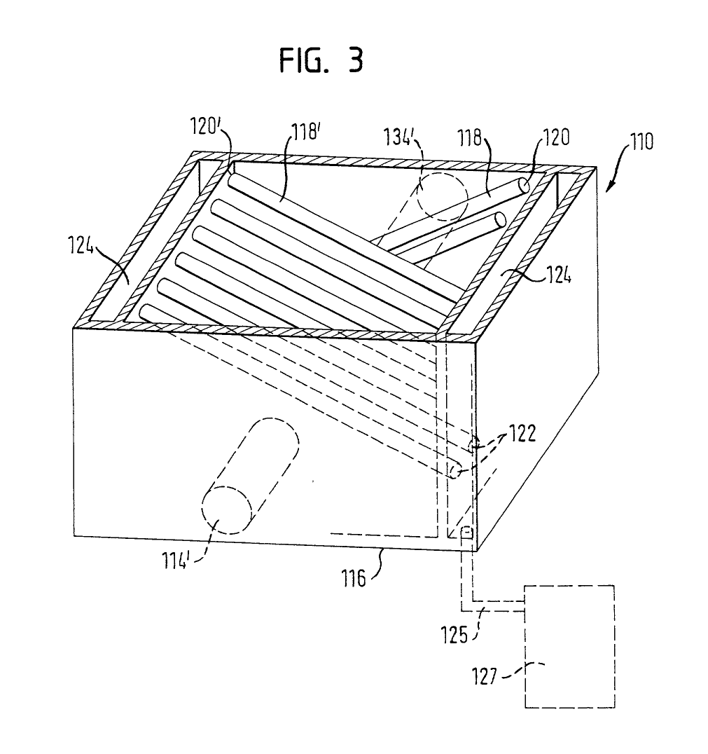

This is in any event somewhat problematic in the arrangement of FIGS. 1 and 2 and it is more favorable, under some circumstances, to select a rectangular cross-section, as is shown in the embodiment of FIG. 3 and as will be explained later in more detail, in place of an approximately circular cross-section of the separating apparatus.

Another possibility is to form the collecting chamber as a ring chamber which concentrically surrounds the diffusion chamber 16.

For the sake of completeness, it is noted at this point that a hydrogen partial pressure difference must exist between the feed gas side and the permeate gas side in order to ensure a hydrogen flow through the membrane walls of the tubes 18. The respective total pressure at the feed gas side and at the permeate gas side consequently says nothing about this required gradient; it is the H₂ partial pressure which must be considered. The flow through the membrane walls can be calculated using the following equation originating from Sievert:

$${J}_{{H}_{2}} = {P}_{O , {H}_{2}} \cdot exp ( - \frac{{E}_{A}}{R \cdot T} ) \cdot \frac{A}{S} \cdot ( {p}_{{H}_{2} , F}^{1 / 2} - {p}_{{H}_{2} , P}^{1 / 2} )$$

where J_{H}_{₂} is the H₂-flow through the membrane walls in mol/second, P_{O,H}_{₂} is a constant for the respective membrane, E_{A} is the activation energy of the membrane, R is the universal gas constant, T is the temperature, A is the membrane area, s is the membrane thickness, p_{H}_{₂}_{,F} is the partial hydrogen pressure at the feed gas side, and p_{H}_{₂}_{P} is the partial hydrogen pressure at the permeate gas side.

One can see from this equation amongst other things that the H₂ flow can be increased by making p_{H}_{₂}_{P}, i.e., the partial hydrogen pressure on the permeate gas side smaller.

This can be achieved in that one directs an inert gas or a carrier gas through the membrane tubes or through the hollow structures. This carrier gas must, however, be compatible for use in a fuel cell, or be capable of being separated again easily from the permeate gas after the fine gas cleaning process. Water vapor is particularly suitable as a carrier gas because it can easily be separated from hydrogen by a simple condensation process. Humidified reaction gases are in any event necessary for certain operating conditions of the fuel cell, so that a proportion of water vapor in the hydrogen supplied to the fuel cells is not disadvantageous.

One possibility of achieving the flow through the membrane tubes or through the hollow structures having the membrane walls of the separating apparatus of the invention is to allow the hollow structures to open at one point into a supply chamber and at another point into a collecting chamber. The carrier gas can then be fed from a supply source via the supply chambers into the hollow structures and then flows with the hydrogen out of the hollow structures into the collecting chamber. The presence of the carrier gas reduces the partial hydrogen pressure in the hollow structures and thus leads to an increased hydrogen movement into the hollow structures. By way of example, the membrane tubes in accordance with FIG. 1 can open at both ends into a chamber, such as 24, with one of these chambers, for example the left-hand chamber, acting as a collecting chamber and the other chamber, the right-hand one in FIG. 1, serving as a supply chamber for the carrier gas or for the water vapor which is here additionally provided with the reference number 24′ in order to make its use as a supply chamber clear. The line shown in broken lines and identified by the reference number 25 which passes from a supply source 27 for the carrier gas into the left-hand chamber 24 shows one way of realizing this embodiment.

In the embodiment of FIG. 3, the same reference numerals are used for components which correspond to those of the embodiment of FIGS. 1 and 2, but are increased by the basic number 100 in order to ensure a clear differentiation. It is straightforwardly evident from the reference numerals that the embodiment of FIG. 3 operates in precisely the same manner as the embodiment of FIGS. 1 and 2, which is why this manner of operation will not be explained again. It should, however, be mentioned that the illustration only shows a few of the crossing tubes 18 in FIG. 3, i.e., many have been omitted in order not to make the drawing unnecessarily complicated.

A separating apparatus 110 in accordance with FIG. 3 would also have the advantage that the throughflow by the gas mixture does not necessarily have to take place in the longitudinal direction, but rather an inlet 114′ and an outlet 134′ for the gas mixture could be provided at opposite sides of the separating apparatus 110 where the collecting chambers are not provided.

In this case, one of the two chambers 124 can also be used as a collecting chamber and the other chamber 124 as a supply chamber for a carrier gas, which is indicated by the line 125 and the supply source 127 illustrated in broken lines in the drawing.

As indicated above, there are many different possibilities of realizing a separating apparatus of the kind of the invention, with it being advantageous in many cases to base the construction of the diffusion chamber on the construction of a static mixer for liquids as known, per se. In a static mixer, there is indeed a completely different task, namely to intensively mix two or more fluids or liquid components with one another over a short distance without movable parts. This type of mixing, however, simultaneously signified that shear forces act on the fluids or liquids which are flowing and which are ultimately the determining factor for the mixing. Such shear forces arise also as a result of the flows within the diffusion chamber of a separating apparatus in accordance with the invention and lead to turbulence and thus to a longer dwell time of the gas mixture within the chamber and accordingly to a higher degree of efficiency of the separating apparatus, i.e., to an increased recovery factor.

Starting from any desired static mixer, one can thus consider whether it is possible to execute the inbuilt structures in the static mixer as hollow structures which must then open at at least one point into a collecting chamber (which would not be present in a static mixer). The hollow structures must then be provided with a wall region which consists at least partly of a membrane permeable for hydrogen, but not for other gases, in order to realize the present invention.

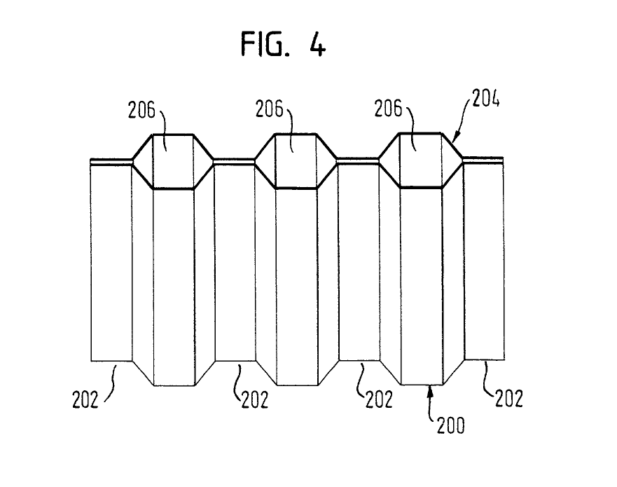

One kind of static mixer which is known uses corrugated sheet metal elements, such as are for example shown in FIG. 4 at 200 and which are arranged obliquely to the flow direction through the static mixer, with flow passages 202 which extend in the longitudinal direction of the corrugations of the sheet metal part being formed by the corrugated shape. Through a crossed arrangement of sequential sheet metal elements, a plurality of changes of direction arise in a static mixer for the components which are flowing through the flow passages and which are to be mixed.

This construction can also be exploited in accordance with FIG. 4 for the purpose of the present invention. Here a second wave-like structure 204 is mounted in mirror-like manner onto the first wave-like structure 200 so that flow passages 206 are formed between two corrugated plates. These flow passages 206 correspond to the hollow spaces within the tubular structure 18 of the embodiment of FIGS. 1 and 2 or 118 of the embodiment of FIG. 3. The passages 202 carry in contrast the gas mixture from which the hydrogen component should be removed as fully as possible. By arranging a component in accordance with FIG. 4 in an oblique position relative to a further similar component, a crossed arrangement of passages 202 for the mixture arises which likewise leads to the desired turbulent flow and to an increase of the dwell time. The hollow structures consist of a plurality of crossing components of this kind. The passages 206 which carry the hydrogen open at their ends, as in the previous embodiments, into corresponding collecting passages. Here, the crossed layers of the corrugated structures are arranged within a container (not shown) which forms the diffusion chamber and which has at suitable positions an inlet and an outlet for the gas mixture or for the gas mixture which is at least partly depleted with respect to its hydrogen component.

1. An apparatus for the separation of hydrogen from a gas mixture including hydrogen and at least a second gas, comprising hollow structures with a wall including a membrane permeable for hydrogen disposed in a diffusion chamber, the mixture can be led into and through the diffusion chamber, the hydrogen which diffuses through the membrane into the hollow structures can be led out of the hollow structures and the gas mixture depleted with respect to its hydrogen content can be led out of the diffusion chamber and wherein the hollow structures comprise crossed tubes which open at least at their one end into a collecting chamber which leads away the hydrogen.

2. An apparatus in accordance with claim 1 wherein the diffusion chamber comprises an elongate diffusion chamber with an inlet for the gas mixture at a first end and an outlet for the mixture depleted with respect to its hydrogen component at a second end.

3. An apparatus in accordance with claim 2 further comprising elongate collecting chambers provided at opposite sides of the diffusion chamber carrying the gas mixture between its ends, with the crossing tubes opening into the collecting chambers at at least one end.

4. An apparatus in accordance with claim 3 wherein the crossing tubes are closed at their ends opposite to the respective collecting chamber.

5. An apparatus in accordance with claim 3 wherein the crossing tubes are open at their two ends and these open ends open into respective collecting chambers which lead away hydrogen.

6. An apparatus in accordance with claim 3 wherein the second gas is water vapor.

7. An apparatus in accordance with claim 6 further comprising a supply chamber and wherein the crossing tubes are open at two ends with one open end opening into a collecting chamber for leading away hydrogen, whereas the other open end opens into a supply chamber.

8. An apparatus in accordance with claim 1 wherein the diffusion chamber which carries the gas mixture has substantially a circular cylindrical shape in cross section.

9. An apparatus in accordance with claim 1 wherein the diffusion chamber which carries the mixture is of rectangular shape in cross section.

10. An apparatus for the separation of hydrogen from a gas mixture comprising hydrogen and at least a second gas, and hollow structures with a wall of a membrane permeable for hydrogen are arranged in a diffusion chamber, so that a mixture can be led into and through the diffusion chamber and so that the hydrogen which diffuses through the membrane into the hollow structures can be led out of the hollow structures and the mixture depleted with respect to its hydrogen content can be led out of the diffusion chamber and the diffusion chamber carrying the gas mixture includes inbuilt structures and is formed in the manner of a static mixer for liquid components, with the inbuilt structures forming the hollow structures including at least a portion of the membrane permeable for hydrogen and which open at at least one point into a collecting chamber which is formed for the leading away of the hydrogen which diffuses through the membrane.

11. An apparatus in accordance with claim 10 wherein the hollow structures open at one point into a supply chamber which forms a part of a means for producing a flow of an inert gas compatible with a fuel cell and/or necessary for it through the hollow structures.

12. An apparatus for the separation of hydrogen from a gas mixture comprising hydrogen and at least a second gas, wherein hollow structures with a wall of a membrane permeable for hydrogen are arranged in a diffusion chamber, the mixture can be led into and through the diffusion chamber, the hydrogen which diffuses through the membrane and passes into the hollow structures can be led out of the hollow structures, and the mixture depleted with respect to its hydrogen content can be led out of the diffusion chamber comprising the hollow structures designed to produce a turbulent flow of the gas mixture through the diffusion chamber carrying the gas mixture and to lead the hydrogen separated out of the gas mixture into at least one collecting chamber which leads away the hydrogen.

13. An apparatus in accordance with claim 12 wherein the hollow structures open at one point into a supply chamber which forms a part of a means for producing a flow of an inert gas compatible with a fuel cell and/or necessary for it through the hollow structures.
